(19) United States
(12) Patent Application Publication
(10) Pub. No.: US 2004/0150701 A1
(43) Pub. Date: Aug. 5, 2004

(54) Ink cartridge

(75) Inventors: Seo-Hyun Cho, Sungnam-City (KR); Myung-Song Jung, Gungpo-City (KR); Young-Su Lee, Suwon-City (KR); Hyung-Hyu Hwang, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/747,313

(22) Filed: Dec. 30, 2003

(30) Foreign Application Priority Data
Jan. 16, 2003 (KR) 2003-3132

(51) Int. Cl. B41J 2/175

(52) U.S. Cl. 347/86

(57) ABSTRACT

An ink cartridge including a container body formed at a lower end of an ink supply pipe and containing ink therein, a porous body disposed inside the container body for containing ink, and a head portion protruding under the container body for having the ink supply pipe formed in a predetermined length and having a head chip supplied with ink from the pipe and spraying the ink on a sheet of paper disposed thereon. The head portion has a groove which is formed by withdrawing a slide core when forming the container body in order to form the ink supply pipe.

### CROSS-REFERENCE TO RELATED APPLICATIONS

This application claims the benefit of Korean Application No. 2003-3132, filed Jan. 16, 2003, in the Korean Intellectual Property Office, the disclosure of which is incorporated herein by reference.

### BACKGROUND OF THE INVENTION

1. Field of the Invention

The present invention relates to an ink cartridge.

2. Description of the Related Art

Generally, an ink cartridge used in an inkjet printer has a body which is filled with ink. The ink is sprayed in small amounts through an ink head on the ink cartridge body onto a sheet of paper.

FIG. 1 is a drawing showing an ink cartridge disclosed in JP10-150102. Referring to FIG. 1, the conventional ink cartridge 1 has a porous body 2 inside a container body 3 for absorbing ink., An ink supplying port 5 connected to an ink head is formed at the lower part of the container body. A protruding portion 6 is formed inside the container body 3 around the ink supplying port 5 near the bottom. The protruding portion 6 effectively squeezes the ink absorbed in the porous body 2 by compressing and pressurizing the porous body 2. Accordingly, a V shape groove 7, and a predetermined bottom space including an inclined surface 8 are formed between the protruding portion 6 and the inner walls of the container body 3.

According to the above structure, the porous body 2 is in close contact with the inner surfaces of the container body 3, and the groove 7 and the inclined surface 8 are formed such that there is no space between the inner walls of the container body 3 and the porous body 2.

In forming the protruding portion 6 for compressing the porous body 2 around the ink supplying port 5 it is unavoidable that the groove 7 and the inclined surface 8 are formed. Also, the manufacturing and design of the porous body 2 is complicated because the porous body 2 must be formed to fit perfectly into the inner space of the container body in contact with the groove 7 and the inclined surface 8.

Although the porous body 2 is manufactured to correspond to the inner shape of the container body 3, a space, i.e., a dead space, may be formed near the groove 7 or the inclined surface 8 due to manufacturing and assembly tolerances. In this case, air may enter the dead space while filling the container body 3 with ink. The air in the dead space can increase the pressure inside the container body 3 if the ink cartridge is used in an area with extreme temperature changes or in low pressure environments, for example, in Mexico City, where the pressure is lower than the atmospheric pressure. If this occurs, the internal pressure of the container body 3 will force ink out of the container body 3, thereby allowing ink to leak through the ink head when a new cartridge is opened.

In addition, the ink pooled in the bottom space, including the groove 7 and the inclined surface 8, is located lower than the upper end of the protruding portion 6, therefore it cannot be supplied through the ink supply port 5. Thus, ink in the dead space cannot be used and is instead wasted.

### SUMMARY OF THE INVENTION

An aspect of the present invention is to solve at least the above and/or other problems and disadvantages and to provide at least the advantages described hereinafter.

Accordingly, one aspect of the present invention is to solve the foregoing and/or other problems by providing an improved ink cartridge to minimize the formation of dead spaces inside the bottom of the container body.

In order to achieve the above aspects and/or other features of the present invention, an ink cartridge including a container body formed at a lower end of an ink supply pipe and containing ink therein, a porous body disposed inside the container body for containing ink, and a head portion protruding under the container body for having the ink supply pipe formed in a predetermined length and having a head chip supplied with ink from the pipe and spraying the ink on a sheet of paper disposed thereon. The head portion has a groove formed by withdrawing a slide core when forming the container body in order to form the ink supply pipe.

The groove is symmetrically formed at both sides in a narrow width direction of the container body.

The groove is formed at one side of the head portion along the width of the container body.

### BRIEF DESCRIPTION OF THE DRAWINGS

The above and/or other aspects of the present invention will be made more apparent by describing various embodiments of the present invention with reference to the accompanying drawings, in which:

FIG. 1 is a sectional view showing a conventional ink cartridge;

FIG. 2 is a perspective view showing an ink cartridge according to an embodiment of the present invention;

FIG. 3 is a sectional view taken along line I-I of FIG. 2;

FIG. 4 is a sectional view taken along line II-II of FIG. 2; and

FIGS. 5 and 6 are sectional views showing an ink cartridge according to another embodiment of the present invention.

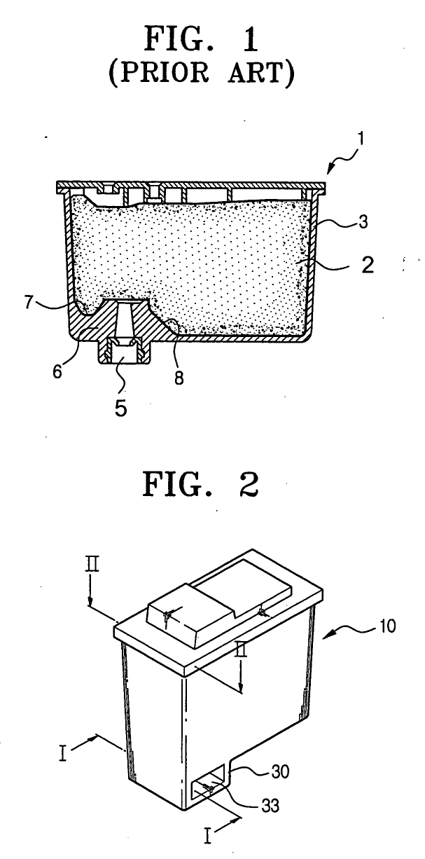

### DETAILED DESCRIPTION OF THE PREFERRED EMBODIMENTS

Hereinafter, an ink cartridge according to various embodiments of the present invention will be described in greater detail with reference to the accompanying drawings.

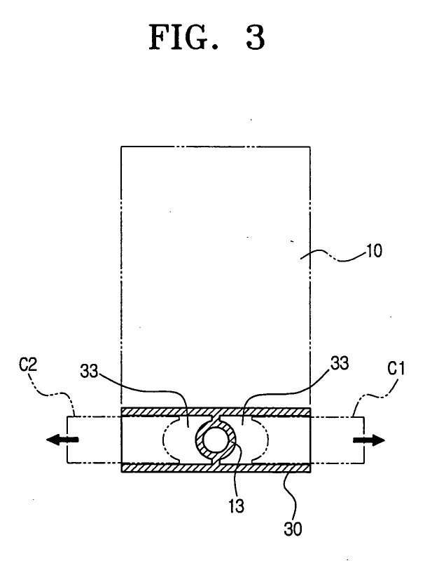

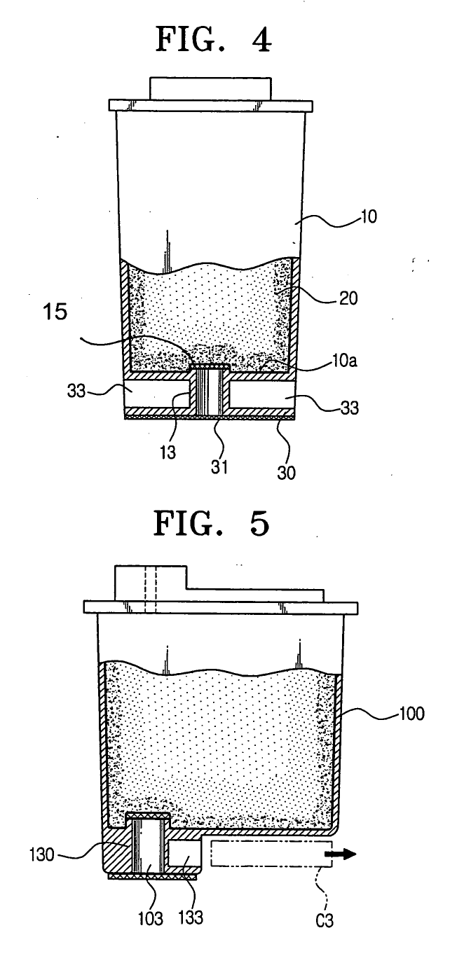

Referring to FIGS. 2 through 4, the ink cartridge according to an embodiment of the present invention comprises a container body 10 for containing ink, a porous body 20 disposed inside the container body 10, and a head portion 30 provided below the container body 10.

The container body 10 has a predetermined shape. The container body has a pipe 13 formed on the bottom for supplying ink. The upper end of the pipe 13 protrudes slightly higher than the level of the bottom surface 10a of the container body 10. The pipe 13 increases the density of the porous body 20 by pressurizing the lower part of the porous body 20. Accordingly, through the pressing portion of the porous body 20, that is, through the part in which the density in increased, ink is squeezed and therefore ink is smoothly supplied.

In addition, a filter 15 is disposed on the upper end of the pipe 13 to filter off impurities and/or air included in the ink.

The porous body 20 is disposed inside the container body 10 for containing ink. The porous body 20 may be formed from an absorbent material such as urethane foam or felt.

A head portion 30 protrudes from the bottom surface of the container body 10. The head portion 30 protrudes approximately as much as the length of the pipe 13. A head chip 31 is located on the outer bottom surface of the head portion 30 to spray ink supplied by the pipe 13.

The head portion 30 has grooves 33 formed by slide cores C1, C2. The slide cores C1, C2 used to form the ink supply pipe 13 are withdrawn during the manufacturing of the container body 10. The grooves 33 are provided symmetrically on both sides of the container body. In other words, during the forming of the container body 10, the grooves 33 are formed on the outer side of the head portion 30 as the slide cores C1, C2, which are used for forming the pipe 13, are withdrawn from the head portion 30. As a result, the grooves 33 formed by the slide cores C1, C2 are not formed inside the container body 10, and therefore, a space, such as a dead space, is not formed inside the container body 10. Thus, air trapped in the dead space while filling the container body 10 and ink leakage due to temperature change are not a concern in this embodiment of the present invention.

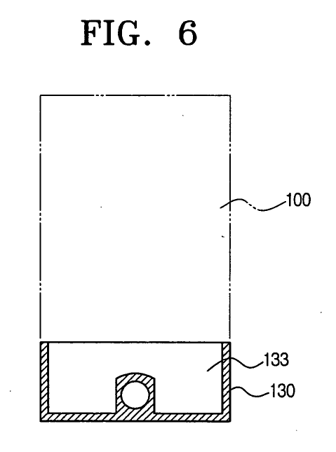

Referring to FIGS. 5 and 6, the ink cartridge according to another embodiment has a groove 133 formed in a head portion 130 of a container body 100. The groove 133 is formed on the outer side of the head portion 130 along the width of the container body 100 in the direction of paper movement. A single groove 133 is formed on either side of the container body along its width. The groove 133 is formed by withdrawing a slide core C3 during formation of the container body 100. The ink supply pipe 103 is formed by the groove 133, and no dead space is created in the bottom of the container body 100, unlike a conventional container body.

The ink cartridge, according to the embodiments of the present invention described above, has the groove formed on the outside of the container body by withdrawing the slide cores when forming the container body. Accordingly, no dead spaces are created around the ink supply pipe.

In addition, ink does not leak due to pressure changes because no dead space is formed. Thus, no air generated during the charging process, is trapped inside the container body.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An ink cartridge comprising:
a container body;
a porous body internal to the container body, containing ink therein;
an ink supply pipe; and
a head portion protruding under the container body and housing the ink supply pipe;
wherein the ink supply pipe is formed using a slide core.

2. The ink cartridge according to claim 1, further comprising:
a filter, attached to a top of the supply pipe to filter impurities and/or air from ink in the porous body; and
a head chip, attached to an outer bottom of the ink supply pipe, to spray ink supplied by the ink supply pipe onto a printing surface.

3. The ink cartridge according to claim 1, wherein the ink supply pipe is formed using a slide core so as to prevent the formation of dead spaces within the container body.

4. The ink cartridge according to claim 1, wherein the ink supply pipe is formed using two symmetrically opposed slide cores.

5. The ink cartridge according to claim 4, wherein two grooves are formed symmetrically on opposite sides of the head portion by removing the slide cores.

6. The ink cartridge according to claim 5, wherein no dead spaces are formed during manufacture.

7. The ink cartridge according to claim 1, wherein a groove is formed along a width of one side of the head portion by removing the slide core.

8. The ink cartridge according to claim 7, wherein no dead spaces are formed during manufacture.

9. The ink cartridge of claim 1, wherein a top of the ink supply pipe extends past a bottom surface of the porous body, thus pressurizing a lower part of the porous body.

10. The ink cartridge according to claim 9, wherein no dead spaces are formed during manufacture.

11. The ink cartridge of claim 1, wherein the porous body is made of urethane foam.

12. The ink cartridge of claim 1, wherein the porous body is made of felt.

13. A method of forming an ink supply pipe in an ink cartridge, comprising:
withdrawing two symmetrically opposed slide cores from a head portion of the ink cartridge during manufacture, thereby leaving two grooves in the head portion.

14. The method of forming an ink cartridge according to claim 13, wherein no dead spaces are formed in the ink cartridge.

15. A method of forming an ink supply pipe in an ink cartridge, comprising:
withdrawing a slid core from a head portion of the ink cartridge during manufacture, thereby leaving a groove in the head portion.

16. The method of forming an ink cartridge according to claim 15, wherein no dead spaces are formed in the ink cartridge.

17. An ink cartridge comprising:
a container body;
a porous body, internal to the container body, and containing ink therein;
an ink supply pipe, connected to the porous body;
a filter, attached to a top of the ink supply pipe to filter impurities and/or air from ink in the porous body;
a head chip, attached to bottom of the ink supply pipe, to spray ink supplied by the ink supply pipe onto on a sheet of paper disposed thereon; and
a head portion protruding under the container body to accommodate the ink supply pipe of a predetermined length, comprising a such that no dead spaces are formed in the container body.

18. The ink cartridge according to claim 17, wherein a top of the ink supply pipe extends above a bottom surface of the porous body.

19. The ink cartridge of claim 17, wherein the porous body is made of urethane foam.

20. The ink cartridge of claim 17, wherein the porous body is made of felt.
